(19) United States
(12) Patent Application Publication
(10) Pub. No.: US 2023/0068286 A1
(43) Pub. Date: Mar. 2, 2023

(54) VEHICLE SEAT

(71) Applicant: Adient US LLC, Plymouth, MI (US)

(72) Inventors: Oliver KUNTZ, Wermelskirchen (DE); Van-Toan HO, Solingen (DE); Frank SCHLUETER, Moers (DE); Thomas ARNDT, Monheim (DE)

(21) Appl. No.: 17/823,259

(22) Filed: Aug. 30, 2022

(30) Foreign Application Priority Data
Sep. 2, 2021 (DE) 10 2021 122 797.6
May 24, 2022 (DE) 10 2022 113 120.3

(51) Int. Cl. B60N 2/04; B60N 2/16

(52) U.S. Cl. CPC B60N 2/045; B60N 2/166; B60N 2002/0236

(57) ABSTRACT

A vehicle seat may have adjustment kinematics and a drive device for driving the adjustment kinematics. The adjustment kinematics may have at least one movable rocker and a transverse tube which is mounted rotatably about an axis of rotation. An end region of the rocker may be connected to the transverse tube for rotation therewith. A toothed segment which is curved about the axis of rotation may be connected to the transverse tube for rotation therewith, and, in order to drive the adjustment kinematics, the toothed segment is rotatable about the axis of rotation by the drive device.

### FIELD

The invention relates to a vehicle seat, having adjustment kinematics and a drive device for driving the adjustment kinematics, the adjustment kinematics having at least one movable rocker and a transverse tube which is mounted rotatably about an axis of rotation, wherein the rocker, in particular an end region of the rocker, is connected to the transverse tube for rotation therewith.

### BACKGROUND

Drive devices for operating or adjusting a seat function are known both for vehicle seat height adjusters and for backrest adjusters. These are often electric drives or mechanical bidirectional step by step switching systems, the actuating angle of which is generally from 15 to 30 degrees, and which transmit a torque only in an actuation direction and are decoupled on the return path from the output. Such mechanisms are conventional as load-absorbing systems in height adjusters. When used as backrest adjusters, the driven backrest fitting, which is designed as a geared fitting, generally absorbs the working loads and crash loads. Known drive devices are disclosed, for example, in DE 197 09 852 A1 and DE 195 40 631 A1.

WO 2020/020754 A1 discloses a vehicle seat, having adjustment kinematics with movable rockers, wherein at least one rocker is mounted rotatably about an axis, and a toothed segment which is connected to the at least one rocker is provided, wherein the vehicle seat has a drive for moving the at least one rocker, and the drive is mounted on a seat frame, in particular on a side part of the seat frame, wherein a pinion of the drive meshes with the toothed segment, and wherein, by aligning the position of the entire drive relative to the side part using a compensating body, the pinion is positioned relative to the toothed segment without play.

DE 10 2015 223 485 A1 discloses a height adjuster for a vehicle seat, wherein a baseplate which is mounted on a side part and holds a drive is aligned relative to the side part of the vehicle seat using a crash bolt.

### SUMMARY

The invention is based on the problem of improving a vehicle seat of the type mentioned at the beginning, in particular of providing a vehicle seat with improved adjustment kinematics.

This problem is solved according to the invention by a vehicle seat having adjustment kinematics and a drive device for driving the adjustment kinematics, the adjustment kinematics having at least one movable rocker and a transverse tube which is mounted rotatably about an axis of rotation, wherein the rocker, in particular an end region of the rocker, is connected to the transverse tube for rotation therewith, wherein a toothed segment which is curved about the axis of rotation is connected to the transverse tube for rotation therewith, and the toothed segment is rotatable about the axis of rotation by the drive device.

Owing to the fact that a toothed segment which is curved about the axis of rotation is connected to the transverse tube for rotation therewith, and, in order to drive the adjustment kinematics, the toothed segment is rotatable about the axis of rotation by the drive device, the adjustment kinematics can be adjusted by rotation of the transverse tube, which is connected to the toothed segment, and the rocker, which is connected to the transverse tube for rotation therewith. Construction space required in the vehicle seat in order to accommodate the drive device for the adjustment kinematics is advantageously reduced.

Advantageous refinements which can be used individually or in combination with one another are the subject matter of the dependent claims.

The drive device can have a motor. The motor can be an electric motor.

The drive device can have a transmission. The transmission can be a reduction transmission. The transmission can be a step-up transmission. The transmission can be a multi-stage transmission. The transmission can have at least one gearwheel. The transmission can have at least one worm gear.

The drive worm can be drivable by the motor. The drive worm can be connected to an output-side shaft of the transmission. The drive worm can be drivable by the transmission. The drive worm can be a component of the transmission. The drive worm can be connected to an output shaft of the transmission.

The transmission can have a transmission housing. The transmission housing can surround the transverse tube at least in sections. The transverse tube can be guided through the transmission housing. The transmission housing can surround at least one portion of the transverse tube which has the toothed segment. The transmission housing can be fixed to the seat frame side part. The motor can be held on the transmission housing. The motor can be held on, in particular screwed to, a flange of the transmission housing.

The adjustment kinematics can be kinematics of an armrest. In this case, the rocker which is connected to the transverse tube can act on an armrest; in particular, an angular position of the armrest relative to a backrest can be adjustable.

The adjustment kinematics can be kinematics of a calf support. In this case, the rocker which is connected to the transverse tube can act on kinematics for retracting and extending a calf support.

The adjustment kinematics can be height adjustment kinematics. The height adjustment kinematics can have a respective four-bar linkage arrangement on both sides of the vehicle seat, as viewed in the transverse direction. The four-bar linkage arrangement can have four coupling members. The four-bar linkage arrangement can be formed from a base, a front rocker, a rear rocker and a seat frame. The coupling members of the four-bar linkage arrangement can be connected in pairs to one another by a respective rotary joint.

A first rotary joint can connect the base pivotably to the rear rocker. A second rotary joint can connect the rear rocker pivotably to the seat frame. A third rotary joint can connect the seat frame pivotably to the front rocker. A fourth rotary joint can connect the front rocker pivotably to the base. The rotary joints can permit a rotational movement about a respective axis parallel to the transverse direction.

The transverse tube can be arranged in the region of the second rotary joint. The rear rockers, in particular in each case an end region of the rear rockers, of the two four-bar linkage arrangements can be connected, in particular fixedly, to the transverse tube for rotation therewith.

The transverse tube can be arranged in the region of the third rotary joint. The front rockers, in particular in each case an end region of the front rockers, of the two four-bar linkage arrangements can be connected, in particular fixedly, to the transverse tube for rotation therewith.

An arrangement of the transverse tube in the region of the first or fourth rotary joint is likewise conceivable. In this case, the drive device can be fixable to the base.

The seat frame can have at least one seat frame side part. The transverse tube can be mounted rotatably in or on the seat frame side part. The drive device can bear against the seat frame side part. The drive device can be fastened to the seat frame side part. The drive device can be arranged on an inner side of a seat frame side part. The drive device can be arranged on an outer side of a seat frame side part. The terms “inner side” and “outer side” relate to the transverse direction. The inner side here is the side, in particular sheet metal side, of the seat frame side part that faces the centre of the seat. The outer side here is the side, in particular sheet metal side, of the seat frame side part that faces away from the centre of the seat.

The seat frame can have a respective seat frame side part on both sides of the seat. The two seat frame side parts can be arranged spaced apart from each other in the transverse direction. The two seat frame side parts can be connected to each other by a crossbar, in particular a front crossbar. The transverse tube can be mounted rotatably in or on the two seat frame side parts. The drive device can be arranged between the two seat frame side parts, wherein the drive device is arranged on an inner side of one of the two seat frame side parts. The drive device can be arranged on an outer side of a seat frame side part (and therefore not between the two seat frame side parts).

In summary and expressed in other words, a vehicle seat is proposed which provides a direct connection of a drive device to a transverse tube which connects the seat frame side parts to each other. The transverse tube has an external toothing, in particular a gearwheel arranged on the outside of the transverse tube, which is drivable by the drive device. The drive device can have a motor, in particular an electric motor, and a transmission unit. The transmission unit can be arranged in a transmission housing. The transmission housing can surround both the transverse tube and the transmission unit. The transmission unit can be a double worm transmission. The drive device can be arranged both on an inner side of a backrest frame side part, i.e. between the backrest frame side parts, and on an outer side of the backrest frame side part opposite the inner side. The drive device can be arranged individually in each case on the door side or tunnel side. Use of such a drive device on both sides may also be possible.

### DESCRIPTION OF THE FIGURES

The invention is explained in more detail below with reference to an advantageous exemplary embodiment illustrated in the figures and with reference to a modification of the exemplary embodiment. However, the invention is not restricted to this exemplary embodiment or to the modification thereof. In the figures:

FIG. 1: shows, in schematized form, a side view of a vehicle seat according to the invention,

FIG. 2: shows, in detail form, a side view of a vehicle seat according to the exemplary embodiment according to the invention in the region of a drive device,

FIG. 3: shows, in detail form, a perspective view of the vehicle seat from FIG. 2 in the region of the drive device,

FIG. 4: shows a view corresponding to FIG. 3, wherein a transmission housing of the drive device is illustrated in transparent form,

FIG. 5: shows a perspective view of the drive device without the transmission housing, and of a transverse tube having a toothed segment,

FIG. 6: shows, in detail form, a view from above of a vehicle seat according to the modification of the exemplary embodiment according to the invention in the region of a drive device, and

FIG. 7: shows, in detail form, a perspective view of the vehicle seat from FIG. 6 in the region of the drive device.

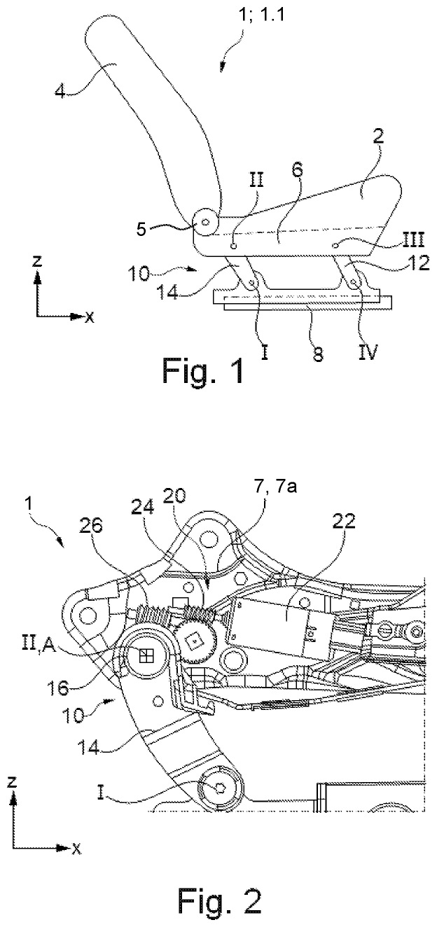

### DETAILED DESCRIPTION

A vehicle seat 1 according to the invention which is illustrated in the figures, and the modification thereof (vehicle seat 1.1), will be described below using three directions in space which run perpendicularly to one another. A longitudinal direction x runs, for a vehicle seat 1; 1.1 installed in the vehicle, largely horizontally and preferably parallel to a longitudinal direction of the vehicle, which corresponds to the customary direction of travel of the vehicle. A transverse direction y, which runs perpendicularly in relation to the longitudinal direction x, is likewise oriented horizontally in the vehicle and runs parallel to a transverse direction of the vehicle. A vertical direction z runs perpendicularly in relation to the longitudinal direction x and perpendicularly in relation to the transverse direction y. For a vehicle seat 1; 1.1 installed in the vehicle, the vertical direction z runs parallel to the vertical axis of the vehicle.

The information used in relation to position and direction, for example front, rear, top, bottom and transversely, relates to a viewing direction of an occupant sitting in the normal sitting position on a seat part 2 of the vehicle seat 1; 1.1, wherein the vehicle seat 1; 1.1 is installed in the vehicle in a use position suitable for transporting a person, and with a backrest 4 upright, and is oriented, as conventionally, in the direction of travel. However, the vehicle seat 1; 1.1 may also be oriented differently, for example installed transversely with respect to the direction of travel. Unless described differently, the vehicle seat 1; 1.1 is constructed mirror-symmetrically with respect to a plane running perpendicularly in relation to the transverse direction y.

The vehicle seat 1; 1.1 has adjustable kinematics 10, in the present case height adjustment kinematics. The adjustment kinematics 10 are used to be able to adjust the height of the vehicle seat 1; 1.1, i.e. a distance in the vertical direction z between a seat surface of the seat part 2 and a vehicle floor can be adjusted, in particular in order to adapt the vehicle seat 1; 1.1 to the height of an occupant.

The vehicle seat 1; 1.1 comprises a seat structure and a plurality of cushion parts carried by the seat structure, the cushion parts comprising foam parts and cushion covers, in particular made from fabric or leather. The backrest 4 has in particular a backrest structure. The seat part 2 has in particular a seat base structure. The backrest structure and the seat base structure essentially form the seat structure. The backrest structure is fastened pivotably to the seat base structure 2 by two fittings 5.

The vehicle seat 1; 1.1 is fastenable to the floor of the vehicle by a base 8, for example having two pairs of seat rails. The seat base structure of the seat part 2 comprises the adjustment kinematics 10. The adjustment kinematics 10 have a respective four-bar linkage arrangement on both sides of the seat, as viewed in the transverse direction y, the four-bar linkage arrangement being formed in each case from the base 8, a front rocker 12, a rear rocker 14, a seat frame 6, and four rotary joints I, II, III, IV. The base 8, the front rockers 12, the rear rockers 14, and the seat frame 6 are connected to one another by the rotary joints I, II, III, IV, as described in more detail below.

The seat frame 6 in each case comprises a seat frame side part 7 on both sides (as viewed in the transverse direction y). In addition, the seat frame 6 has a transverse tube 16. The two seat frame side parts 7 are arranged spaced apart from each other. The transverse tube 16 extends between the two seat frame side parts 7. In the present case, the transverse tube 16 is arranged in a rear region of the seat frame 6. In a front region of the seat frame 6, the two seat frame side parts 7 are connected to each other preferably by a front crossbar.

On both sides of the seat (as viewed in the transverse direction y), a respective first rotary joint I connects the base 8 pivotably to the respect rear rocker 14. On both sides of the seat, a second rotary joint II connects the respective rear rocker 14 pivotably to the seat frame 6. On both sides of the seat, a respective third rotary joint III connects the seat frame 6 pivotably to the respective front rocker 12. On both sides of the seat, a respective fourth rotary joint IV connects the respective front rocker 12 pivotably to the base 8. The rotary joints I, II, III, IV in each case permit a rotational movement about a respective axis which is parallel to the transverse direction y.

The height adjustment kinematics 10 can be used to adjust a distance (a height) between the seat surface of the seat part 2 and the vehicle floor (and therefore the base 8).

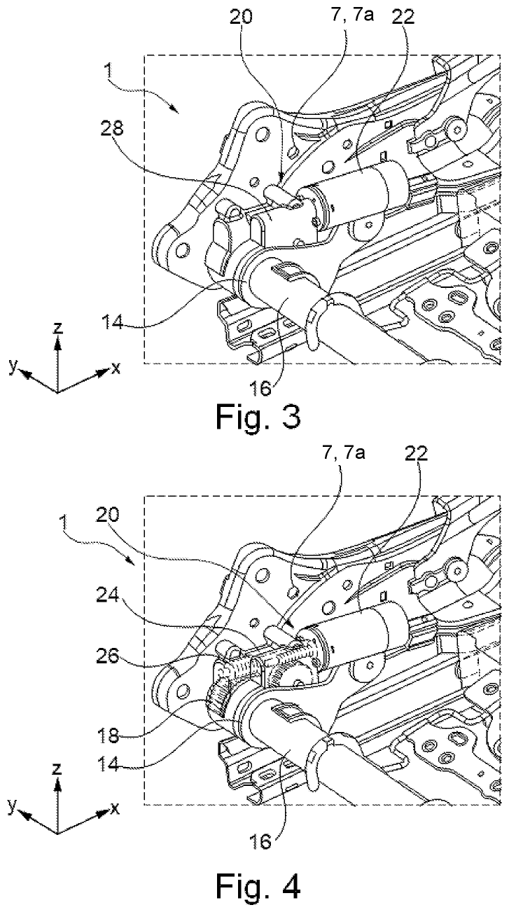

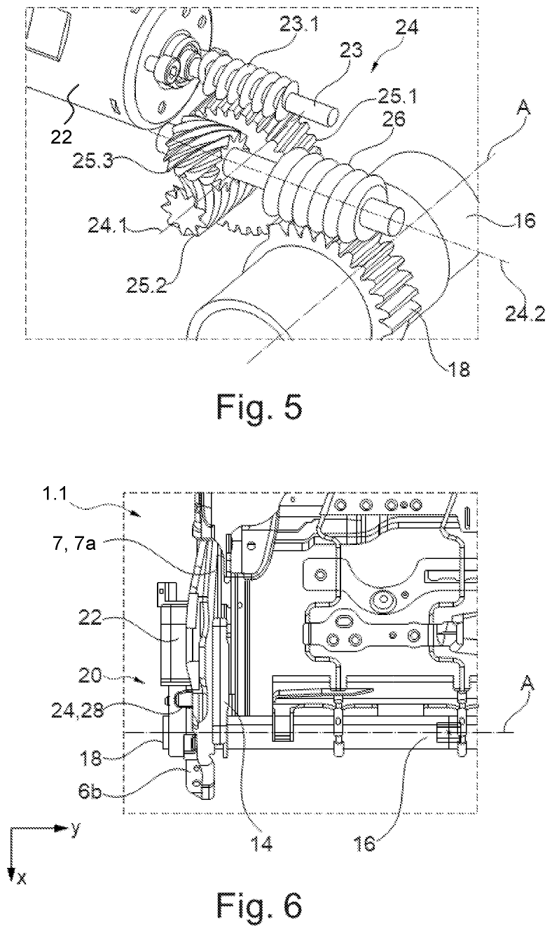

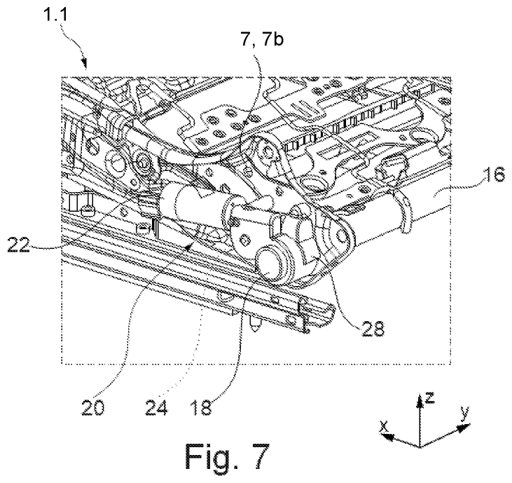

The above description of the vehicle seat 1; 1.1 is applicable both to the exemplary embodiment (vehicle seat 1) which is described below and is illustrated in FIGS. 2 to 5, and also to the modification thereof (vehicle seat 1.1) illustrated in FIGS. 6 and 7.

FIGS. 2 to 5 show, in detail form, a vehicle seat 1 according to the embodiment according to the invention.

In order to drive and to lock the height adjustment kinematics 10, the rear rockers 14 arranged on both sides of the seat are each connected at one end to a transverse tube 16 for rotation therewith. The transverse tube 16 is mounted rotatably about an axis of rotation A with respect to the seat frame side parts 7. The axis of rotation A here forms a centre axis of the transverse tube 16. The transverse tube 16 is preferably mounted rotatably in openings in the respective seat frame side parts 7. The axis of rotation A preferably runs through the two second rotary joints II.

The vehicle seat 1 has a drive device 20. The drive device 20 is arranged on an inner side 7a of one of the two seat frame side parts 7. The drive device 20 has a motor 22 and a transmission 24 which is drivable by the motor 22.

The motor 22 has a motor output shaft 23. The motor output shaft 23 is arranged within a transmission housing 28 of the transmission 24. A worm 23.1 is connected to the motor output shaft 23 for rotation therewith.

The transmission 24 has a first transmission shaft 24.1 and a second transmission shaft 24.2 which run rotated in relation to each other by 90 degrees and are arranged in a transmission housing 28. The first transmission shaft 24.1 is mounted rotatably in the transmission housing 28. The second transmission shaft 24.2 is mounted rotatably in the transmission housing 28. The second transmission shaft 24.2 can be an output shaft of the transmission 24.

A worm gear 25.1 and a first helical gear 25.2 of the transmission 24 are mounted rotatably in the transmission housing 28. The worm gear 25.1 and the first helical gear 25.2 are connected to each other for rotation with each other. The worm gear 25.1 and the first helical gear 25.2 are connected to the transmission shaft 24.1 for rotation therewith. Alternatively, the worm gear 25.1 and the first helical gear 25.2 can form the first transmission shaft 24.1.

A second helical gear 25.3 and a drive worm 26 of the transmission 24 are mounted rotatably in the transmission housing 28. The second helical gear 25.3 and the drive worm 26 are connected to each other for rotation with each other. The second helical gear 25.3 and the drive worm 26 are connected to the second transmission shaft 24.2 for rotation therewith. Alternatively, the second helical gear 25.3 and the drive worm 26 can form the second transmission shaft 24.2.

The motor output shaft 23 and the first transmission shaft 24.1 run rotated in relation to each other by 90 degrees. The worm 23.1 meshes with the worm gear 25.1. Therefore, by actuation of the motor 22 and resulting rotation of the motor output shaft 23, the first transmission shaft 24.1 is rotated. A reduction ratio between the motor output shaft 23 and the first transmission shaft 24.1 is, for example, 31.

The first helical gear 25.2 and the second helical gear 25.3 mesh with each other. Rotation of the first transmission shaft 24.1 therefore results in rotation of the second transmission shaft 24.2. A reduction ratio between the first transmission shaft 24.1 and the second transmission shaft 24.2 is, for example, 11/9.

The drive worm 26 meshes with a toothed segment 18 which is curved about the axis of rotation A. The toothed segment 18 is connected to the transverse tube 16 for rotation therewith. Rotation of the second transmission shaft 24.2 therefore results in rotation of the transverse tube 16. A reduction ratio between the drive worm 26 and the toothed segment 18, and therefore between the second transmission shaft 24.2 and the transverse tube 16, is, for example, 33.

By actuation of the motor 22, the transverse tube 16 and the rear rockers 14, which are connected thereto for rotation therewith, are pivotable. As a result, the adjustment kinematics 10 are adjustable. The toothed segment 18 is adapted in the circumferential direction to a maximum pivoting range of the rear rockers 14 and therefore to a maximum pivoting range of the transverse tube 16. Alternatively, the toothed segment 18 can be a fully revolving gearwheel.

The transmission housing 28 partially surrounds the transverse tube 16 in the region of the toothed segment 18. The transmission housing 28 is connected fixedly to the seat frame side part 7. The motor 22 is fastened to the transmission housing 28. For this purpose, the motor 22 can be fixed, in particular screwed, to a flange of the transmission housing 28.

FIGS. 6 and 7 show, in detail form, the vehicle seat 1.1 according to the modification of the exemplary embodiment. The vehicle seat 1.1 corresponds in respect of construction and function to the previously described vehicle seat 1, unless exclusively described differently below.

The vehicle seat 1.1 according to the modification of the exemplary embodiment differs from the vehicle seat 1 according to the previously described exemplary embodiment only in that the drive device 20 and the toothed segment 18 are arranged on an outer side 7b of one of the seat frame side parts 7. The drive device 20 can be covered on the outer side 7b of the seat frame side part 7 by a panelling, not illustrated.

The toothed segment 18 which is curved about the axis of rotation A can be fixed to an end face of the transverse tube 16. The toothed segment 18 can axially extend the transverse tube 16. The toothed segment 18 is preferably hollow-cylindrical. However, the toothed segment 18 can alternatively be manufactured from a solid material and be connected at one end of the transverse tube 16 to the transverse tube 16 for rotation therewith.

In further modifications of the exemplary embodiment, a respective drive device is provided analogously on both sides of the seat.

The features disclosed in the above description, the claims and the drawings may be important both individually and in combination for the purpose of realizing the various configurations of the invention.

### LIST OF REFERENCE SIGNS

1 Vehicle seat
1.1 Vehicle seat
2 Seat part
4 Backrest
5 Fitting
6 Seat frame
7 Seat frame side part
7a Inner side
7b Outer side
8 Base
10 Adjustment kinematics (height adjustment kinematics)
12 (front) rocker
14 (rear) rocker
16 Transverse tube
18 Toothed segment
20 Drive device
22 Motor
23 Motor output shaft
23.1 Worm
24 Transmission
24.1 first transmission shaft
24.2 second transmission shaft
25.1 Worm gear
25.2 first helical gear
25.3 second helical gear
26 Drive worm
28 Transmission housing
A Axis of rotation
I first rotary joint
II second rotary joint
III third rotary joint
IV fourth rotary joint
x Longitudinal direction
y Transverse direction
z Vertical direction

1-10. (canceled)

11. A vehicle seat, comprising:
adjustment kinematics and,
a drive device for driving the adjustment kinematics,
wherein the adjustment kinematics have at least one movable rocker and a transverse tube which is mounted rotatably about an axis of rotation, wherein an end region of the rocker, is connected to the transverse tube for rotation therewith,
wherein a toothed segment which is curved about the axis of rotation is connected to the transverse tube for rotation therewith, and the toothed segment is rotatable about the axis of rotation by the drive device.

12. The vehicle seat according to claim 11, wherein the drive device has an electric motor, and a transmission.

13. The vehicle seat according to claim 11, wherein a drive worm of the drive device meshes with the toothed segment.

14. The vehicle seat according to claim 13, wherein the drive worm is connected to an output shaft of the transmission for rotation therewith.

15. The vehicle seat according to claim 12, wherein the transmission is designed as a multi-stage reduction transmission.

16. The vehicle seat according to claim 12, wherein a transmission housing of the transmission surrounds the transverse tube at least in sections.

17. The vehicle seat according to claim 11, wherein the adjustment kinematics are designed as height adjustment kinematics, wherein the height adjustment kinematics can be used to adjust a distance between a base and a seat frame.

18. The vehicle seat according to claim 17, wherein the seat frame has at least one seat frame side part, wherein the transverse tube is mounted rotatably in or on the seat frame side part.

19. The vehicle seat according to claim 18, wherein the drive device is arranged on an inner side of the seat frame side part.

20. The vehicle seat according to claim 18, wherein the drive device is arranged on an outer side of the seat frame side part.
